(19) United States
(12) Patent Application Publication
(10) Pub. No.: US 2017/0022105 A1
(43) Pub. Date: Jan. 26, 2017

(54) PRODUCTION METHOD OF SEAWALL CONCRETE BLOCK AND THE CONCRETE BLOCK MADE WITH THIS METHOD

(71) Applicant: TRUNG HAU MANUFACTURING CO., LTD., Ho Chi Minh City (VN)

(72) Inventor: NGHIA TRUNG TRAN, Ho Chi Minh City (VN)

(73) Assignee: TRUNG HAU MANUFACTURING CO., LTD., Ho Chi Minh City (VN)

(21) Appl. No.: 15/189,614

(22) Filed: Jun. 22, 2016

(30) Foreign Application Priority Data
Jun. 23, 2015 (VN) 1-2015-02252

(51) Int. Cl. C04B 22/00; C04B 14/48; B28B 23/02; C04B 28/04

(52) U.S. Cl. CPC C04B 22/0006; C04B 28/04; C04B 14/48; B28B 23/02; C04B 2111/74

(57) ABSTRACT

The present invention relates to production of a seawall concrete block, comprising the following steps:
(i) meter and mix all materials with water to create a batch mixture with humidity ranging from 4% to 10%, wherein the batch components of the concrete blocks are in the following proportion (% by weight): cement (5 to 25%), mixture of fly ash and coal slag (15 to 95%); aggregate (0 to 60%):
(ii) press the batch mixture collected from (i) in the mold with the compressive force of ≧2 MPa, after that, remove the mold to obtain the seawall concrete block.

Besides, the present invention relates to a seawall concrete block obtained by this production method.

### FIELD OF THE INVENTION

The present invention relates to a seawall concrete block and production method of this seawall concrete block. The method in the present invention uses fly ash, coal slag from thermal power plant as the materials, thus, helping dispose these wastes effectively. These seawall concrete blocks are used on shoreline for encroachment on the sea, for erosion control, sea embankment protection or in breakwaters.

### BACKGROUND ART

Currently, the wastes of fly ash and coal slag are usually disposed by dumping, causing severe environmental pollutions and scattering dust into the air.

On the other hand, to encroach the sea or block the waves, protect seashore or seawall, etc. such materials as sand, stones and precast concrete blocks with various shapes as shown in FIG. 1A, FIG. 1B, FIG. 1C, FIG. 1D, FIG. 1E, FIG. 1F, FIG. 1G, FIG. 1H, and FIG. 1I. These concrete blocks are produced by natural casting method with such primary materials as sand, stone, cement, etc., mixed with water and poured into the mold to form the shape, with or without rebar. However, these concrete blocks have encountered the following problems: their cost prices are high due to use of common materials in construction area; their productivity is low due to having to use multiple molds; it takes time for the concrete to settle, and the mold can usually be opened after one day or longer; the production cycle prolongs due to manual mold collapsing; it is difficult to cast solid blocks such as cubes because of material-consuming and prone-to-cracking nature. Furthermore, the durability of these concrete blocks is low, they can only last for several years dependent on the conditions of usage, even if they are made with Sulfate Resistant Cement.

Therefore, a production method of seawall concrete blocks with high efficiency, short production cycle for higher productivity and lower cost prices; and seawall concrete blocks with durability that can meet with the demand of encroaching on the sea and keeping the waves off the shore are needed.

### SUMMARY OF THE INVENTION

A basis object of the present invention overcome the above problems, namely, to use the primary materials comprising fly ash—coal slag and cement to form seawall concrete blocks by the semi-dry pressing method with high pressure, which has production line that is possibly automated, good quality, competitive cost and environment-friendly materials that can be made from wastes of fly ash and coal slag for serving this endless need.

In order to achieve the above object, the present invention proposes:

[1] Production method of the seawall concrete blocks comprises the following steps:

(i) meter and mix all materials with water to create a batch mixture with humidity ranging from 4% to 10%, wherein the batch components of the concrete blocks are in the following proportion (% by weight): cement (5 to 25%), mixture of fly ash and coal slag (15 to 95%); aggregate (0 to 60%);

(ii) press the batch mixture collected from (i) in the mold with the compressive force of 2 MPa, after that, remove the mold to obtain the seawall concrete block.

[2] The method according to section 1, wherein the mixture of fly ash and coal slag is directly collected from thermal power plant, comprising fly ash accounting for 20 to 90% of total weight and coal slag accounting for 10 to 80% of total weight.

[3] The method according to section 1 or 2, wherein the rebar is put into the mold before loading the batch mixture into the mold.

[4] The seawall concrete block obtained by the method according to section 1, wherein this concrete block comprises cement (accounting for 5 to 25% of total weight), mixture of fly ash and coal slag (accounting for 15 to 95% of total weight); aggregate (accounting for 0 to 60% of total weight);

[5] The seawall concrete block according to section 4, wherein the mixture of fly ash and coal slag is directly collected from thermal power plant, comprising fly ash accounting for 20 to 90% of total weight and coal slag accounting for 10 to 80% of total weight.

[6] The seawall concrete block according to section 4 or 5, wherein this concrete block comprises rebar.

### BRIEF DESCRIPTION OF DRAWINGS

In the following section, the seawall concrete block can be formed with usual shapes as known and described in FIG. 1A, FIG. 1B, FIG. 1C, FIG. 1D, FIG. 1E, FIG. 1F, FIG. 1G, FIG. 1H, and FIG. 1I as basic polygonal blocks with 4, 5 or 6 faces.

FIG. 1A, FIG. 1B, FIG. 1C, FIG. 1D, FIG. 1E, FIG. 1F, FIG. 1H, and FIG. 1I, comprise shapes of seawall concrete blocks that can be used in the present invention.

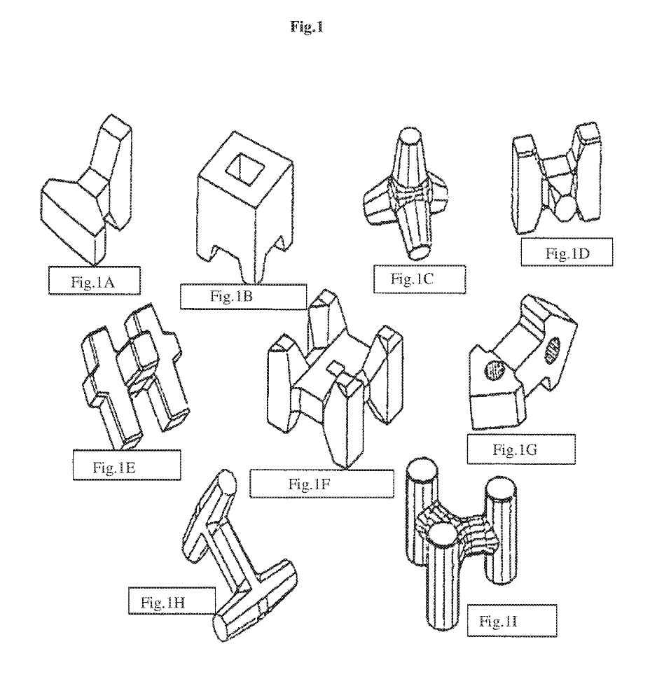

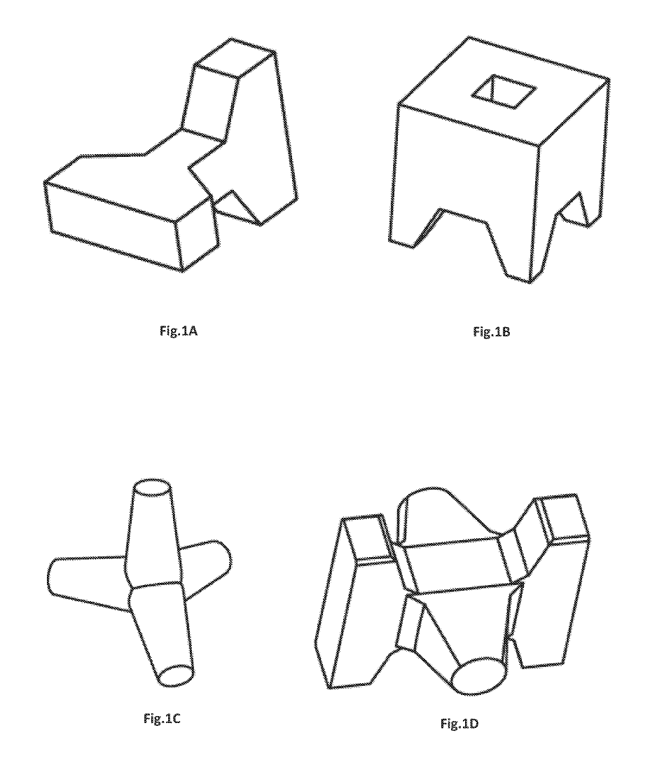

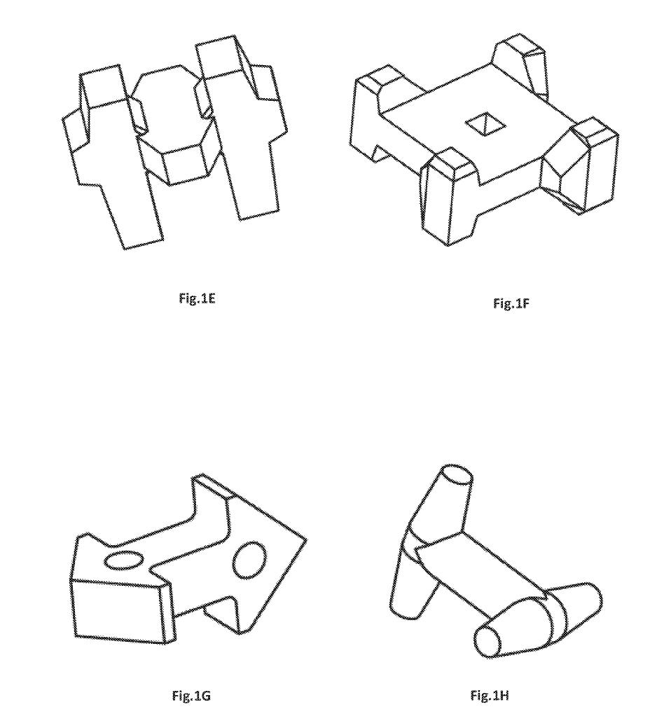

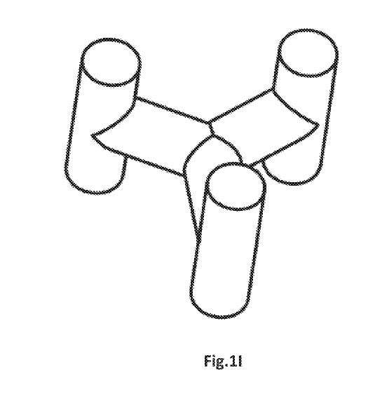

### DESCRIPTION OF THE PREFERRED EMBODIMENTS

Detailed descriptions of the present invention according to each preferred embodiment are as follows.

Production Method of the Seawall Concrete Blocks

The method according to present invention comprises two major steps:

(i) meter and mix all materials with water to create a batch mixture with humidity ranging from 4% to 10%, wherein the batch components of the concrete blocks are in the following proportion (% by weight): cement (5 to 25%), mixture of fly ash and coal slag (15 to 95%) aggregate (0 to 60%);

(ii) press the hatch mixture collected from (i) in the mold with the compressive three of ≧2. MPa, after that, remove the mold to obtain the seawall concrete block.

Materials, as known as batch mixture are metered with predefined portion, are premixed in a dry state, to which then at is added to obtain he semi-dry mixture with the humidity ranging from 4% to 10%. This demi-dry batch mixture: is premixed in a dry state to uniform, then loaded into the mold for pressing. The mold and non-stick treatment for inner surface of the mold are implemented with common methods. Preferably double-movement pressing method should be employed, i.e., comprising top-down and bottom-up pressing. The minimum compressive force of 2. MPa is supposed to speed up binding process of the batch mixture, thus the concrete block, after being pressed, can be removed from the mold right away without having to wait for the settlement, which usually takes one day. High compressive forces such as 5, 10, 15 MPa or above are preferred. Compressive forces of less than 2 MPa are not preferred because concrete block that has not been strictly pressed is prone to crack and break after being removed from e mold. With the compressive forces of more than 2 MPa, the mold can be removed as soon as it is pressed with the expected compressive force in order that the next cycle can be started, thus, time to produce a concrete block is declined, and accordingly the productivity is increased. The concrete block, after being removed from the mold, are humidified and preserved with normal method, then it can be used as final product.

The cements suitable for se in the present invention are all available on the market such as mixed Portland cements PCB30, PCB40 or cement made from red mud of the same inventor, which has been described in the utility model No. 2-0001203 (VN2-2014-00195). Sulfate Resistant Cements available on the market can be used but not preferred because of their high prices. Preferably, cement from red mud of the same inventor should be used for the highest technical efficiency and the lowest costs. Cement in the dry batch mixture accounts for 5 to of total weight, other values in this range such as 10, 15, 20% or any other one can all be of use.

The mixture of fly ash and coal slag, as known as coal fired power plant bottom, are collected directly from the disposal site of the power plant. Their components can change over time and plant, but mostly they contain silicon oxide, calcium oxide, aluminum oxide, unburnt fixed carbon and are consider an artificial puzzolan. The ratio of fly ash and coal slag can be based on the existing ratio when they are collected from the factory, which is commonly coal slag:fly ash=1:9, however it is possible to add more coal slag in case there is abundant supply of coal slag, thus the mixture of fly ash and coal slag can contain fly ash accounting for 20 to 90% of total weight, coal slag accounting for 10 to 80% of total weight. The amount of mixture of fly ash and coal slag accounts for 15 to 95% of total weight of the dry batch mixture.

The amount of aggregate accounts for 0 to 60% of total weight of the dry batch mixture, wherein the aggregate is commonly used in construction area, which is mixture of sand, quarry fines, fragmented rocks, debris from stoneware and construction materials, etc.

In a preferred embodiment, the rebar is located in the mold before loading the dry batch mixture, thanks to which the solidity of concrete blocks is enhanced.

The terminology “humidity” used in the present invention is translated as the percentage of added water weight in comparison with total weight of the dry batch mixture, humidity of 4% is translated as 4 kg water added to 100 kg dry batch mixture. The water amount added to the mixture is only enough to create semi-dry batch mixture, but not as smooth as in the normal method of mixing concrete.

Seawall Concrete Block

The seawall concrete block obtained from the method in the present invention is durable in the seawater environment, its intensity is high, which is suitable for encroaching on the sea in replacement of soil, sand, stone; or used in breakwaters to protect embankment base and prevent erosion. The seawall concrete block in the present invention comprises cement (accounting for 5 to 25% of total weight), mixture of fly ash and coal slag (accounting for 15 to 95% of total weight); aggregate (accounting for 0 to 60% of total weight).

### EXAMPLE OF THE PRESENT INVENTION

The experiments are carried out with the sample of concrete cube according to TCVN 3118:1993 with sizes of a=b=c=150 mm.

### Example 1

The batch components are in the following proportion (% by weight):

Fly ash and coal slag collected from Vinh Tan 2 thermal power plant: 80%.

Cement PCB 40: 20%.

This batch is mixed with 7% of water (out of 100% of total weight of dry batch mixture), then ompressed in the mold with the compressive forces changing over batches. The testing results are as follows:

| | Intensity (strength) of the concrete |
|---|---|
| Forming pressing force (MPa) | block (MPa) |
| 2.69 | 8.3 |
| 4.00 | 8.8 |
| 6.54 | 9.2 |
| 7.06 | 9.9 |
| 7.90 | 11.0 |
| 10.61 | 11.3 |
| 12.69 | 11.4 |

### Example 2

The batch components are in the following proportion (% by weight):

Fly ash and coal slag collected from Vinh Tan 2 thermal power plant: 65%.

Aggregate of quarry fines: 20%

Cement PCB 40: 15%

This batch is mixed with 7% of water (out of 100% of total weight of dry batch mixture), then ompressed in the mold with the compressive forces changing over batches. The testing results are as follows:

| | Intensity (strength) of the concrete |
|---|---|
| Forming pressing force (MPa) | block (MPa) |
| 3.02 | 8.9 |
| 4.13 | 9.5 |
| 5.18 | 10.1 |
| 7.69 | 11.4 |
| 9.06 | 11.5 |
| 10.41 | 12.8 |

### Example 3

The batch components are in the following proportion (% by weight):

Fly ash and coal slag collected from Vinh Tan 2 thermal power plant: 65%

Aggregate of sand: 20%

Cement PCB 40: 15%

This hatch is mixed with 7% of water (out of 100% of total weight of dry batch mixture), then compressed in the mold with the compressive forces changing over hatches. The testing results are as follows:

| Forming pressing force | Intensity (strength) of the concrete |
|---|---|
| (MPa) | block (MPa) |
| 2.07 | 7.5 |
| 3.57 | 9.5 |
| 7.62 | 11.5 |
| 9.80 | 11.9 |
| 11.61 | 12.1 |
| 14.88 | 12.8 |

Achievable Benefits

Effectively deal with environmental pollutions because it makes maximum use of fly ash and coal slag collected from thermal power plants;

Create an endless source of materials to encroach on the sea, a possible replacement of other materials in question;

The production process can be automated with high productivity;

Environment-friendly, it is possible to save the traditional materials of sand and stone for production of concrete.

1. A method of making a seawall concrete block comprises the following steps:
(i) metering and mixing all materials with water to create a batch mixture with humidity ranging from 4% to 10%, wherein the batch components of the concrete blocks are in the following proportion (% by weight): cement (5 to 25%), mixture of fly ash and coal slag (15 to 95%), and aggregate (0 to 60%);
(ii) pressing thebatch t ixture collected from (i) in the mold with the a compressive force of ≧2 MPa, after that, removing the mold to obtain the seawall concrete block.

2. The method according to claim 1, wherein the mixture of fly ash and coal slag is directly collected from thermal power plant, comprising fly ash accounting for 20 to 90% of total weight and coal slag accounting for 10 to 80% of total weight.

3. The method according to claim 1, wherein rebar is put into the mold before loading the batch mixture into the mold.

4. A seawall concrete block obtained by a method comprising the following steps:
(i) metering and mixing all materials with water to create a batch mixture with humidity ranging from 4% to 10%, wherein the batch components of the concrete blocks are in the following proportional percentage by weight cement accounting for 5 to 25% of total weight, mixture of fly ash and coal slag accounting for 15 to 95% of total weight, and aggregate accounting for 0 to 60% of total weight,
(ii) pressing the batch mixture collected from (i) in the mold with a compressive force of ≧2 MPa, after that, removing the mold to obtain the seawall concrete block.

5. The seawall concrete block according to claim 4, wherein the mixture of fly ash and coal slag is directly collected from thermal power plant, comprising fly ash accounting for 20 to 90% of total weight and coal slag accounting for 10 to 80% of total weight.

6. The seawall concrete block according to claim 4, wherein the concrete block comprises rebar.

7. The method according to claim 2, wherein rebar is put into the mold before loading the batch mixture into the mold.

8. The seawall concrete block according to claim 5, wherein the concrete block comprises rebar.
